(19) United States
(12) Patent Application Publication
(10) Pub. No.: US 2025/0243097 A1
(43) Pub. Date: Jul. 31, 2025

(54) INTEGRATION OF WET AIR OXIDATION AND ELECTRO-OXIDATION METHODS FOR THE DESTRUCTION OF PER- AND POLYFLUORINATED ALKYL SUBSTANCES (PFAS)

(71) Applicant: Lummus Technology LLC, Houston, TX (US)

(72) Inventors: Mark Allan Clark, Wausau, WI (US); Chad Felch, Kronenwetter, WI (US)

(21) Appl. No.: 19/036,227

(22) Filed: Jan. 24, 2025

Related U.S. Application Data
(60) Provisional application No. 63/624,919, filed on Jan. 25, 2024.

(51) Int. Cl. C02F 9/00; C02F 1/28; C02F 1/461; C02F 1/467; C02F 1/74; C02F 101/36

(52) U.S. Cl. CPC C02F 9/00; C02F 1/28; C02F 1/46104; C02F 1/4672; C02F 1/74; C02F 2101/36; C02F 2301/046

(57) ABSTRACT

Methods of and systems for the destruction of per-and polyfluorinated alkyl substances (PFAS) in water are provided. The water treatment method includes a wet air oxidation (WAO) treatment step followed by an electro-oxidation treatment step. The disclosed methods and systems are capable of destroying PFAS present in water streams and/or adsorption media, including groundwater, drinking water, or industrial or municipal wastewater.

### CROSS-REFERENCE TO RELATED APPLICATION

This application claims priority to and any benefit of U.S. Provisional Application No. 63/624,919, filed Jan. 25, 2024, the content of which is incorporated herein by reference in its entirety.

### FIELD

The present disclosure relates to methods of and systems for the destruction of per- and polyfluorinated alkyl substances (PFAS). More particularly, the present disclosure relates to a water treatment method including a wet air oxidation (WAO) treatment step upstream from an electro-oxidation treatment step. The disclosed methods and systems are capable of destroying PFAS present in water streams and/or adsorption media, including groundwater, drinking water, or industrial or municipal wastewater.

### BACKGROUND

Water sources including groundwater, drinking water, or wastewater often include undesirable contaminants. One class of contaminants that presents a growing concern is perfluoroalkyl and polyfluoroalkyl substances (“PFAS”), colloquially known as “forever chemicals.” Specifically, it has become a public health priority in the United States and abroad to mitigate the effects of PFAS on the human population by preventing such contaminants from being ingested.

PFAS may be removed from a water stream using conventional adsorptive media technologies including, e.g., activated carbon or ion exchange. However, the adsorption media merely provides a means for removing—not destroying—PFAS from the water stream. The adsorption media contaminated with the collected PFAS must thereafter be disposed of.

Conventional methods of disposing contaminated adsorption media have been found to be insufficient. For example, there is inconclusive evidence as to whether incineration effectively destroys PFAS, as data collected from samples near incinerators burning PFAS adsorption media have shown elevated concentrations of PFAS remaining after otherwise presumed destruction. The more common conventional approach of disposing contaminated adsorption media in landfills has come under increasing scrutiny due to the dangers and pervasiveness of PFAS contamination in groundwater. For example, it has been noted that over time, the leachate from landfills begins to accumulate PFAS.

As such, a need exists for effective methods of destroying PFAS present in water streams or other sources of PFAS-contaminated adsorption media.

### SUMMARY

Disclosed herein are methods of and systems for the destruction of per- and polyfluorinated alkyl substances (PFAS). The methods and systems include a wet air oxidation (WAO) unit 101, an electro-oxidation unit 102, and a captured PFAS adsorption media unit 103.

In accordance with a first aspect of the present disclosure, a method of destroying per- and polyfluorinated alkyl substances (PFAS) in a flowable stream is disclosed. The method comprises: (a) directing an inlet stream 20 into a wet air oxidation (WAO) unit 101, the inlet stream 20 comprising water, solids, and PFAS, wherein the WAO unit 101 solubilizes a portion of the solids in the inlet stream 20 to provide a WAO effluent stream 22; (b) directing the WAO effluent stream 22 to an electro-oxidation unit 102; (c) applying a current to the electro-oxidation unit 102 to oxidize at least a portion of the PFAS in the WAO effluent stream 22 to provide an electro-oxidation effluent stream 26; and (d) directing the electro-oxidation effluent stream 26 to a captured PFAS adsorption media unit 103, wherein the captured PFAS adsorption media unit 103 removes at least a portion of the PFAS from the electro-oxidation effluent stream to produce a treated outlet stream 34.

In a second aspect of the disclosure, which may be combined with any other aspect listed herein unless specified otherwise, the solids of inlet stream 20 comprise adsorptive media.

In a third aspect of the disclosure, which may be combined with any other aspect listed herein unless specified otherwise, the method further comprises directing at least a portion of the WAO effluent stream 22 back to the WAO unit 101 as a WAO treated recycle stream 24.

In a fourth aspect of the disclosure, which may be combined with any other aspect listed herein unless specified otherwise, a majority portion of the WAO effluent stream 22 is directed back to the WAO unit 101 as the WAO treated recycle stream 24.

In a fifth aspect of the disclosure, which may be combined with any other aspect listed herein unless specified otherwise, the method further comprises directing at least a portion of the electro-oxidation effluent stream 26 back to the WAO unit 101 as an electro-oxidation treated recycle stream 28.

In a sixth aspect of the disclosure, which may be combined with any other aspect listed herein unless specified otherwise, the electro-oxidation treated recycle stream 28 is combined with the WAO treated recycle stream 24.

In a seventh aspect of the disclosure, which may be combined with any other aspect listed herein unless specified otherwise, the method further comprises directing a captured PFAS adsorption media stream 32 from the captured PFAS adsorption media unit 103 to the WAO unit 101.

In an eighth aspect of the disclosure, which may be combined with any other aspect listed herein unless specified otherwise, the method further comprises directing the WAO effluent stream 22 to a separator unit 504, wherein the separator unit 504 is downstream from the WAO unit 101 and upstream from the electro-oxidation unit 102.

In a ninth aspect of the disclosure, which may be combined with any other aspect listed herein unless specified otherwise, the separator unit 504 separates at least a portion of the PFAS from the WAO effluent stream 22, and wherein the separator unit 504 provides separate outlet streams comprising a concentrated electro-oxidation inlet stream 52 and a raffinate stream 54.

In a tenth aspect of the disclosure, which may be combined with any other aspect listed herein unless specified otherwise, the concentrated electro-oxidation inlet stream 52 is directed to the electro-oxidation unit 102.

In an eleventh aspect of the disclosure, which may be combined with any other aspect listed herein unless specified otherwise, the raffinate stream 54 is directed to the captured PFAS adsorption media unit 103.

In a twelfth aspect of the disclosure, which may be combined with any other aspect listed herein unless specified otherwise, at least a portion of the electro-oxidation treated recycle stream 28 is directed for processing in the separator unit 504.

In accordance with a thirteenth aspect of the present disclosure, a system for destroying per-and polyfluorinated alkyl substances (PFAS) is disclosed. The system comprises: (a) a wet air oxidation (WAO) unit 101 configured to solubilize a portion of solids in an inlet stream 20, the inlet stream 20 comprising water, the solids, and PFAS; (b) an electro-oxidation unit 102 downstream from the WAO unit 101, wherein the electro-oxidation unit 102 is configured to receive a WAO effluent stream 22 and provide an electro-oxidation effluent stream 26; (c) a means for providing a current to the electro-oxidation unit 102, wherein the current is sufficient to promote oxidation of at least a portion of the PFAS in the WAO effluent stream 22 within the electro-oxidation unit 102; and (d) a captured PFAS adsorption media unit 103 downstream from the electro-oxidation unit 102, wherein the captured PFAS adsorption media unit 103 is configured to remove at least a portion of the PFAS from the electro-oxidation effluent stream 26 to produce a treated outlet stream 34.

In a fourteenth aspect of the disclosure, which may be combined with any other aspect listed herein unless specified otherwise, the solids of inlet stream 20 comprise adsorptive media.

In a fifteenth aspect of the disclosure, which may be combined with any other aspect listed herein unless specified otherwise, the system further comprises a WAO treated recycle stream 24 configured to flow from a point downstream from the WAO unit 101 to a point upstream from the WAO unit 101.

In a sixteenth aspect of the disclosure, which may be combined with any other aspect listed herein unless specified otherwise, the system further comprises an electro-oxidation treated recycle stream 28 configured to flow from a point downstream from the electro-oxidation unit 102 to the WAO unit 101.

In a seventeenth aspect of the disclosure, which may be combined with any other aspect listed herein unless specified otherwise, the system further comprises a captured PFAS adsorption media stream 32 directed to flow from the captured PFAS adsorption media unit 103 to the WAO unit 101.

In an eighteenth aspect of the disclosure, which may be combined with any other aspect listed herein unless specified otherwise, the system further comprises a separator unit 504 upstream from the electro-oxidation unit 102 and downstream from the WAO unit 101.

In a nineteenth aspect of the disclosure, which may be combined with any other aspect listed herein unless specified otherwise, the separator unit 504 is configured to separate at least a portion of the PFAS from the WAO effluent stream 22.

In a twentieth aspect of the disclosure, which may be combined with any other aspect listed herein unless specified otherwise, a concentrated electro-oxidation inlet stream 52 is configured to flow from the separator unit 504 to the electro-oxidation unit 102.

In a twenty first aspect of the disclosure, which may be combined with any other aspect listed herein unless specified otherwise, a raffinate stream 54 is configured to flow from the separator unit 504 to the captured PFAS adsorption media unit 103.

In a twenty second aspect of the disclosure, which may be combined with any other aspect listed herein unless specified otherwise, an electro-oxidation treated recycle stream for further separation 56 is configured to flow from a point downstream from the electro-oxidation unit 102 to the separator unit 504.

### DESCRIPTION OF THE FIGURES

The advantages of the inventive concepts will be apparent upon consideration of the following detailed disclosure, especially when taken in conjunction with the accompanying drawings wherein:

FIG. 1 illustrates a block flow diagram of an exemplary water treatment system in accordance with the present disclosure; and

FIG. 2 illustrates a block flow diagram of another embodiment of a water treatment system in accordance with the present disclosure.

### DETAILED DESCRIPTION

Disclosed herein are methods of and systems for the destruction of per- and polyfluorinated alkyl substances (PFAS). While the present disclosure describes certain embodiments of the methods and systems in detail, the present disclosure is to be considered exemplary and is not intended to be limited to the disclosed embodiments.

As used herein, the term “COD” or “Chemical Oxygen Demand,” refers to a measure of the amount of oxygen required to fully oxidize organic and inorganic contaminants in wastewater. COD measurement includes biologically labile, biologically inhibitory, and biologically refractory compounds. Unless otherwise specified, it should be understood that COD does not refer to the presence or measure of PFAS contaminants, as those specific compounds are described separately herein.

A used herein, the term “unit” generally refers to a unit operation. A unit operation may be one or more basic operations in a process. A unit may have one or more sub-units (or subsystems). Unit operations may involve a physical change or chemical transformation, such as separation, crystallization, evaporation, filtration, polymerization, isomerization, other reactions, or combinations thereof. A unit may include one or more individual components.

As used herein, the terms “water” and “water stream” encompass any water to be treated such as surface water, ground water, and a stream of wastewater from industrial, agricultural, and municipal sources, having pollutants of biodegradable material, inorganic, labile organic compounds capable of being decomposed by bacteria, biologically refractory compounds, and/or biologically inhibitory compounds, flowing or otherwise introduced into a water treatment system.

Reference will be made to the figures to further describe the methods and systems of the present disclosure. It should be appreciated that the features illustrated in the figures are not necessarily drawn to scale. In the figures, the direction of fluid flow is indicated by arrows. Fluid may be directed from one unit to another, for example, with the aid of valves and a fluid flow system. As those of skill in the art will appreciate, such fluid flow systems may include compressors and/or pumps, as well as a control system for regulating fluid flow.

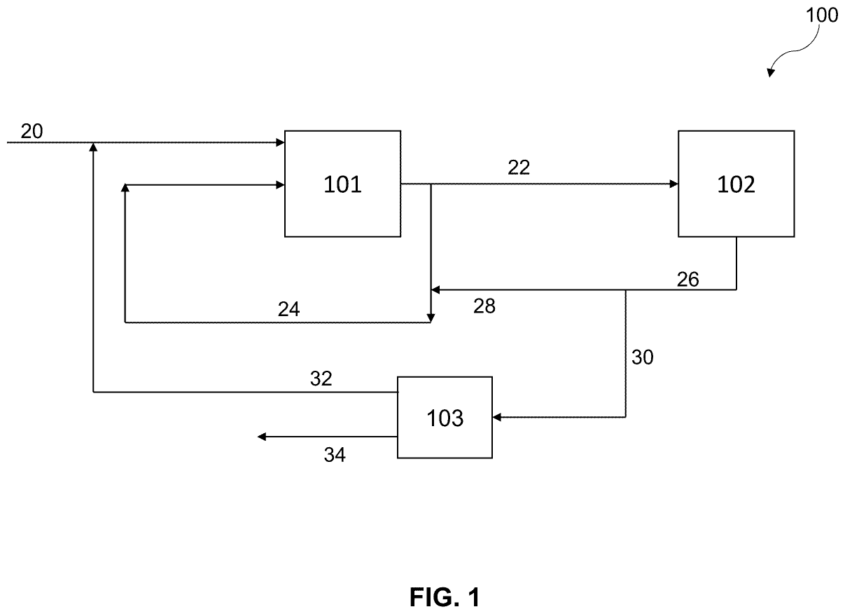

With reference to FIG. 1, a block flow diagram of a water treatment system 100 is shown. The system 100 comprises a wet air oxidation (WAO) unit 101, an electro-oxidation unit 102, and a captured PFAS adsorption media unit 103.

In general, an inlet stream 20 entering the water treatment system 100 comprises contaminants including, inter alia, per- and polyfluorinated alkyl substances (PFAS). Inlet stream 20 may comprise a water stream, including groundwater, drinking water, or industrial or municipal wastewater.

The inlet stream 20 may instead, or additionally, comprise adsorption media contaminated with PFAS. As is known in the art, PFAS may be removed (i.e., collected) from a water stream using conventional adsorptive media technologies including, e.g., activated carbon or ion exchange. Accordingly, inlet stream 20 may comprise adsorption media contaminated with PFAS from an external or upstream water treatment source (not shown in FIG. 1).

As shown in FIG. 1, the wet air oxidation (WAO) unit 101 is configured to receive the inlet stream 20. The WAO unit 101 comprises one or more dedicated reactor vessels, and provides aqueous phase oxidation of undesirable constituents by an oxidizing agent at an elevated temperature and pressure. The oxidizing agent may comprise molecular oxygen from an oxygen-containing gas, including, for example, a pressurized oxygen-containing gas supplied by a compressor. The oxidant may be added to the inlet stream 20 prior to, during, or after flow of the inlet stream 20 through a heat exchanger (not shown in FIG. 1). The inlet stream 20 is thus treated in the WAO unit 101 in a hydrothermal process to solubilize and reduce the COD associated with the adsorption media (e.g., activated carbon or ion exchange media) in the inlet stream 20. The solubilized organic constituents include carbon dioxide, water, and biodegradable short chain organic acids, such as acetic acid. Inorganic constituents including sulfides, mercaptides, and cyanides may also be oxidized. One particular operational benefit of the disclosed WAO process is the recovery of heat released from the exothermic reactions that occur when the adsorption media is oxidized, which can reduce operating expenses. In some aspects, the oxidation process in the WAO unit is carried out at a temperature of from 150° C. to 300° C., including from 175° C. to 300° C., including from 200° C. to 280° C., including from 200° C. to 260° C., including less than 260° C. In some aspects, the oxidation process in the WAO unit is carried out at a pressure of from 300 psig to 3,000 psig, including from 300 psig to 2,000 psig, including from 500 psig to 1,000 psig, including less than 1,000 psig, including from 600 psig to 900 psig, including at 800 psig.

With continued reference to FIG. 1, a WAO effluent stream 22 exits the WAO unit 101 and is fed to the electro-oxidation unit 102. In some aspects, a portion of the WAO effluent stream 22 may be redirected back to the WAO unit 101 for further processing as a WAO treated recycle stream 24. The WAO treated recycle stream 24 may constitute any portion of the WAO effluent stream 22. In some aspects, the WAO treated recycle stream 24 constitutes the majority of the WAO effluent stream 22, with only a minor portion of the WAO effluent stream 22 being directed to the electro-oxidation unit 102. The recirculation of the WAO treated recycle stream 24 has thus been found to optimize the stream entering the electro-oxidation unit 102, in that the COD of the WAO effluent stream 22 is minimized and PFAS concentration of the WAO effluent stream 22 is maximized. In sum, the WAO treatment serves to move PFAS contaminants from a solid phase adsorbent media to a liquid (i.e., water-based) phase for downstream electro-oxidation processing.

The electro-oxidation unit 102 is configured to destroy PFAS contaminants in the WAO effluent stream 22 to a desired level. In general, the electro-oxidation unit 102 comprises subcomponents (not pictured) including, inter alia, a pump, a filter, a cooler, a power supply, and a reactor. The pump, if used, may include any type of pump operable to draw fluid from an intake or source and direct that fluid at a desired flow rate and pressure through the electro-oxidation process. The filter may be positioned to filter larger contaminants and debris from the fluid prior to the fluid passing through the cooler. The cooler operates to cool the fluid to a desired temperature before the fluid is directed to the reactor. The reactor uses electrically conductive, freestanding, substrate-less, synthetic diamond electrodes. For example, the electro-oxidation unit 102 may incorporate one or more boron doped diamond (BDD) electrodes. Electrical current is provided to the electrode by the power supply.

In general, electro-oxidation is a treatment process that flows water between electrodes, while simultaneously passing an electrical current through the electrodes. As the electrical current jumps between the electrodes and through the water, it splits apart some of the water molecules, forming hydroxyl radicals (OH—) and hydrogen ions (H+). The hydroxyl radicals are strong oxidizers that are able to oxidize and mineralize organic molecules they encounter, including fluorocarbons. The PFAS is thus converted to carbon dioxide and fluoride ions, thereby removing the contamination from the inlet stream. Electro-oxidation has been shown to destroy PFAS of all different carbon lengths.

The degree of PFAS destruction and COD reduction in the electro-oxidation treatment step corresponds directly to the current density and the amount of time the electro-oxidation step is operated. In accordance with the present disclosure, the electro-oxidation process is carried out a current density of from 5,000 A/m² to 50,000 A/m², including from 5,000 A/m² to 30,000 A/m², including from 5,000 A/m² to 10,000 A/m², including from 5,000 A/m² to 7,500 A/m², including at 5,000 A/m². The electro-oxidation step may be operated as a continuous process or as a batch process.

The features of the electro-oxidation process that takes place within the electro-oxidation unit 102 are further described in co-pending U.S. Pat. Appln. Pub. No. 2023/0024923, which is incorporated by reference herein in its entirety.

With continued reference to FIG. 1, an electro-oxidation effluent stream 26 exits the electro-oxidation unit 102. For example, the electro-oxidation effluent stream 26 may be sent from the electro-oxidation unit 102 after the concentration of COD has dropped to a level where the electro-oxidation process becomes mass transfer limited (by way of a non-limiting example, at COD<3,000 mg/L). In accordance with the present disclosure, a portion of the electro-oxidation effluent stream 26 may be redirected back to the WAO unit 101 as an electro-oxidation treated recycle stream 28. The electro-oxidation treated recycle stream 28 may be combined with the WAO treated recycle stream 24 for further processing in the WAO unit 101. Alternatively, or additionally, the electro-oxidation treated recycle stream 28 may directly proceed to further processing in the WAO unit 101.

The remainder of the electro-oxidation effluent stream 26 (i.e., the portion of the electro-oxidation effluent stream 26 not constituting the electro-oxidation treated recycle stream 28) is directed to a captured PFAS adsorption media unit 103 as an electro-oxidation treated purge stream 30.

The captured PFAS adsorption media unit 103 comprises any suitable adsorption media, including those known in the art of water treatment, such as activated carbon or ion exchange. The adsorption media of the captured PFAS adsorption media unit 103 removes PFAS from the inlet electro-oxidation treated purge stream 30. In accordance with the present disclosure, the effluent from the captured PFAS adsorption media unit 103 comprises a treated outlet stream 34, which may be disposed of to a wastewater treatment plant. In accordance with the present disclosure, the PFAS concentration in the treated outlet stream 34 is suitable to meet local environmental discharge standards.

In at least some aspects of the present disclosure, the effluent from the captured PFAS adsorption media unit 103 separately comprises a captured PFAS adsorption media stream 32, which may be recycled back into the system upstream from the WAO unit 101. Accordingly, the system 100 provides treatment for not only the external PFAS adsorption media that is present in inlet stream 20, but likewise provides a closed system PFAS destruction means for the saturated adsorption media of the captured PFAS adsorption media unit 103.

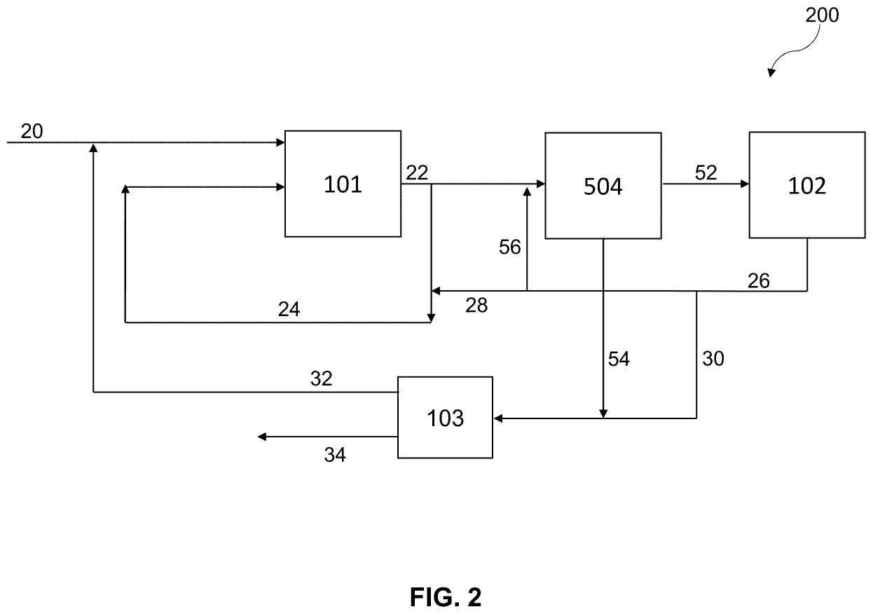

With reference to FIG. 2, a block flow diagram of a water treatment system 200 is shown. The system 200 comprises each of the material components of system 100 in FIG. 1, with the addition of a separator unit 504.

As shown in FIG. 2, the WAO effluent stream 22 exits the WAO unit 101 and is fed to the separator unit 504. The separator unit 504 functions to concentrate the WAO effluent stream 22 prior to treatment in the electro-oxidation unit 102. The separator unit 504 may comprise a device suitable for reverse osmosis or foam fractionation. It should be understood that the separator unit 504 can be substituted with any device suitable for facilitating the separation of some portion of PFAS from some portion of the soluble COD in the WAO effluent stream 22. The separator unit 504 thus increases the efficiency of the PFAS destruction in the downstream electro-oxidation unit 102 by eliminating a portion of the COD. It should be understood that it is within the purview of this disclosure to incorporate a separations method prior to electro-oxidation even in embodiments not including a freestanding separations unit. For example, the wet air oxidation (WAO) unit 101 may incorporate an additional separations step. Additionally, or separately, the electro-oxidation unit 102 may incorporate an additional separations step.

With further reference to FIG. 2, a concentrated electro-oxidation inlet stream 52 exits the separator unit 504 and is directed to the electro-oxidation unit 102 to destroy PFAS contaminants in the concentrated electro-oxidation inlet stream 52 to a desired level. The electro-oxidation process proceeds as previously described for the electro-oxidation unit 102 with reference to FIG. 1.

In addition to the concentrated electro-oxidation inlet stream 52, the concentration process within the separator unit 504 may also produce a raffinate stream 54. The raffinate stream 54 may be directly routed to the captured PFAS adsorption media unit 103 for further processing, or may optionally be combined with the electro-oxidation treated purge stream 30 upstream from the captured PFAS adsorption media unit 103.

Finally, with continued reference to FIG. 2, a portion of the electro-oxidation effluent stream 26 may be redirected back to the WAO unit 101 as an electro-oxidation treated recycle stream 28. Alternatively, or additionally, some or all of the electro-oxidation treated recycle stream 28 may redirected into the process downstream from the wet air oxidation (WAO) unit 101 and upstream from the separator unit 504, so as to allow further processing in the separator unit 504. This electro-oxidation treated recycle stream for further separation is depicted in FIG. 2 as stream 56.

As set forth previously, conventional modes of removing PFAS using adsorptive media technologies including, e.g., activated carbon or ion exchange, have shown to be effective in the sense of a reduction of the presence of such contaminants in a water stream. However, the adsorption media merely provides a means for removing—not destroying—PFAS from the water stream. The adsorption media contaminated with the collected PFAS must thereafter be disposed of, and prior to the instant disclosure, an effective means of selectively removing the PFAS from the adsorption media had not been found.

Electro-oxidation is a known process to destroy PFAS contaminants in water, i.e., the use of a high current density to destroy PFAS. However, electro-oxidation is a power intensive process, and does not provide selective destruction of contaminants. Accordingly, PFAS are destroyed along with all other contaminants in the inlet stream. While electro-oxidation is able to destroy an inlet slurry comprising a saturated adsorption media (i.e., solids) and PFAS-contaminated water on a lab scale, the extremely high operating costs (e.g., in electricity usage) of single-step electro-oxidation so as to directly destroy both the adsorption media solids and the PFAS contaminants on an industrial scale would be economically unfeasible.

Separately, wet air oxidation (WAO) has generally been invoked as a solution to PFAS contaminants in water. However, conventional knowledge in the art is that subcritical (i.e., low temperature) WAO processing is not sufficiently effective at destroying PFAS. As such, in order to provide a single-step WAO destruction of PFAS, it has been found that supercritical water oxidation (SCWAO) is necessary. Specifically, in order to reach the requisite efficacy of PFAS destruction, the SCWAO process operates above 374° C., with some SCWAO processes requiring a temperature as high as 500° C. to 650° C. While a destruction of PFAS is observed on a lab scale in such processes, there is not sufficient heat release from the SCWAO reactions to be able to heat the fluid to these supercritical temperatures unless additional heat or fuel is added (i.e., there is little to no opportunity for heat recovery). Moreover, the supercritical fluid presents manufacturing issues to the SCWAO process, including corrosiveness and fouling tendency.

Here, though, the inventors have surprisingly found that the combination of wet air oxidation upstream from electro-oxidation provides a near total destruction of PFAS and adsorption media from an inlet stream, and further, provides substantial processing efficiencies from an economical perspective. The inventors have found that subcritical WAO processing is effective as a first step to downstream electro-oxidation processing, as opposed to the previously suggested single step processing of either SCWAO or electro-oxidation. These results have been shown to be synergistic, rather than simply additive, particularly from a manufacturing efficiency perspective. By operating the WAO process at subcritical temperatures instead of supercritical temperatures, the inventors have found that heat recovery can be applied, and thus the system as a whole is more energy efficient. In applications of the present disclosure above 10,000 mg/L of COD, for example, the WAO reaction heat release is greater than what is required to heat the solutions for the WAO reactions to begin. The net result is a highly energy efficient WAO step, or further, may even provide a manufacturing opportunity for exporting heat.

Moreover, as set forth previously, electro-oxidation as a stand-alone step has high capital and operating costs when destroying PFAS adsorption media solids. Specifically, in order to sufficiently destroy PFAS compounds, high current density electro-oxidation is required. However, utilizing the requisite high current density needed for PFAS against an entire inlet adsorption media (i.e., direct electro-oxidation of all oxidizable materials in a wastewater adsorptive media matrix) is highly inefficient and results in exorbitant energy costs. Here, by conducting an upstream WAO step, the inlet stream to the high current density electro-oxidation unit contains substantially lower concentrations of superfluous COD associated with the adsorption media. As such, the high current density electro-oxidation step is specifically targeted to PFAS destruction, without wasting costly resources (e.g., electricity) on COD destruction.

In sum, the inventors have found that the combination of WAO and electro-oxidation provides a flexible, cost-effective solution for destroying PFAS-containing adsorption media.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods and systems of the present disclosure can comprise, consist of, or consist essentially of the essential elements of the disclosure as described herein, as well as any additional or optional element described herein, or which is otherwise useful in water treatment applications.

In accordance with the present disclosure, it is possible to utilize the various inventive concepts in combination with one another. Additionally, any particular feature recited as relating to a particularly disclosed aspect of the methods and systems of the present disclosure should be interpreted as available for use with all disclosed aspects of the methods and systems of the present disclosure, unless incorporation of the particular feature would be contradictory to the express terms of the disclosed aspect. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

What is claimed is:

1. A method of destroying per- and polyfluorinated alkyl substances (PFAS) in a flowable stream, the method comprising:
(a) directing an inlet stream into a wet air oxidation (WAO) unit, the inlet stream comprising water, solids, and PFAS, wherein the WAO unit solubilizes a portion of the solids in the inlet stream to provide a WAO effluent stream;
(b) directing the WAO effluent stream to an electro-oxidation unit;
(c) applying a current to the electro-oxidation unit to oxidize at least a portion of the PFAS in the WAO effluent stream to provide an electro-oxidation effluent stream; and
(d) directing the electro-oxidation effluent stream to a captured PFAS adsorption media unit, wherein the captured PFAS adsorption media unit removes at least a portion of the PFAS from the electro-oxidation effluent stream to produce a treated outlet stream.

2. The method of claim 1, wherein the solids of inlet stream comprise adsorptive media.

3. The method of claim 1, further comprising directing at least a portion of the WAO effluent stream back to the WAO unit as a WAO treated recycle stream.

4. The method of claim 3, wherein a majority portion of the WAO effluent stream is directed back to the WAO unit as the WAO treated recycle stream.

5. The method of claim 1, further comprising directing at least a portion of the electro-oxidation effluent stream back to the WAO unit as an electro-oxidation treated recycle stream.

6. The method of claim 5, wherein the electro-oxidation treated recycle stream is combined with the WAO treated recycle stream.

7. The method of claim 1, further comprising directing a captured PFAS adsorption media stream from the captured PFAS adsorption media unit to the WAO unit.

8. The method of claim 1, further comprising directing the WAO effluent stream to a separator unit, wherein the separator unit is downstream from the WAO unit and upstream from the electro-oxidation unit.

9. The method of claim 8, wherein the separator unit separates at least a portion of the PFAS from the WAO effluent stream, and wherein the separator unit provides separate outlet streams comprising a concentrated electro-oxidation inlet stream and a raffinate stream.

10. The method of claim 9, wherein the concentrated electro-oxidation inlet stream is directed to the electro-oxidation unit.

11. The method of claim 9, wherein the raffinate stream is directed to the captured PFAS adsorption media unit.

12. The method of claim 8, wherein at least a portion of the electro-oxidation treated recycle stream is directed for processing in the separator unit.

13. A system for destroying per-and polyfluorinated alkyl substances (PFAS), the system comprising:
(a) a wet air oxidation (WAO) unit configured to solubilize a portion of solids in an inlet stream, the inlet stream comprising water, the solids, and PFAS;
(b) an electro-oxidation unit downstream from the WAO unit, wherein the electro-oxidation unit is configured to receive a WAO effluent stream and provide an electro-oxidation effluent stream;
(c) a means for providing a current to the electro-oxidation unit, wherein the current is sufficient to promote oxidation of at least a portion of the PFAS in the WAO effluent stream within the electro-oxidation unit; and
(d) a captured PFAS adsorption media unit downstream from the electro-oxidation unit, wherein the captured PFAS adsorption media unit is configured to remove at least a portion of the PFAS from the electro-oxidation effluent stream to produce a treated outlet stream.

14. The system of claim 13, further comprising a WAO treated recycle stream configured to flow from a point downstream from the WAO unit to a point upstream from the WAO unit.

15. The system of claim 13, further comprising an electro-oxidation treated recycle stream configured to flow from a point downstream from the electro-oxidation unit to the WAO unit.

16. The system of claim 13, further comprising a captured PFAS adsorption media stream directed to flow from the captured PFAS adsorption media unit to the WAO unit.

17. The system of claim 13, further comprising a separator unit upstream from the electro-oxidation unit and downstream from the WAO unit.

18. The system of claim 17, wherein the separator unit is configured to separate at least a portion of the PFAS from the WAO effluent stream.

19. The system of claim 17, wherein a concentrated electro-oxidation inlet stream is configured to flow from the separator unit to the electro-oxidation unit.

20. The system of claim 17, wherein an electro-oxidation treated recycle stream for further separation is configured to flow from a point downstream from the electro-oxidation unit to the separator unit.
